(19) United States
(12) Patent Application Publication
(10) Pub. No.: US 2008/0258654 A1
(43) Pub. Date: Oct. 23, 2008

(54) COMBINATION PNEUMATIC AND ELECTRIC LINEAR ACTUATOR

(76) Inventor: Edward J. NEFF, Del Mar, CA (US)

Correspondence Address: MORRISON & FOERSTER LLP, 12531 HIGH BLUFF DRIVE, SUITE 100, SAN DIEGO, CA, 92130-2040, US

(21) Appl. No.: 12/020,466

(22) Filed: Jan. 25, 2008

Related U.S. Application Data
(60) Provisional application No. 60/897,695, filed on Jan. 26, 2007.

(51) Int. Cl. B25J 9/10; H02K 41/02

(52) U.S. Cl. 318/1; 310/12; 318/135

(57) ABSTRACT

A linear actuator system can move a probe along a substantially linear path. The linear actuator system can have a housing with a magnet mounted in the housing creating a magnetic field. An electric coil piston can be slidably mounted in the housing. The coil piston can have a coil for carrying a current and can be disposed for translational movement within the magnetic field in response to current flow through the coil. The probe can be attached to the coil for translational movement with the coil. In addition, a pneumatic cylinder can be connected to the piston configured to apply a force to the piston in response to an activation of the pneumatic cylinder. Accordingly, the linear actuator system can combine the beneficial compact force capability of pneumatic cylinders with the programmable control features of linear electric motors, which can result in highly repeatable, high-force linear actuator systems. Such a system can last a long time, have “soft lands” and also work relatively quietly

### CROSS-REFERENCE TO RELATED APPLICATIONS

This application claims priority from U.S. provisional application 60/897,695 filed Jan. 26, 2007. The contents of this document are incorporated herein by reference.

### FIELD OF THE INVENTION

This disclosure relates to linear actuators and, more particularly to a linear actuator that combines features of a moving coil actuator and a pneumatic cylinder.

### BACKGROUND OF THE INVENTION

Direct pneumatic linear cylinders can be an effective means of applying relatively high forces in a compact package. A 50 mm bore cylinder, for example, operating at 5 bar line pressure, can apply a kilo-gram force of approximately 75 KGF.

However such a device can have drawbacks. Poor control of speed and a lack of programmability can lead to slamming of the piston into cushioned end stops in fast cycle applications, often resulting in pneumatic failure of the device. Applications where cylinder failure occurs in hundreds of hours are not uncommon. Additionally, relatively high friction caused by seals under pressure in combination with other components used to control the cylinder, e.g., air valves and speed controls, can result in an inconsistent repeatable operation. This can be on the order of +/−10s of milliseconds. This all can make for poor results in high cycle critical response time work. More over, the violent impact can result in a noisy environment.

Direct linear electric motion, on the other hand, can show almost an inverse in an advantage/disadvantage analysis. An electric servo linear motor (such as SMAC's LA50 series or MLA50 series, manufactured by SMAC, Inc. of Carlsbad, Calif.) can be a relatively poor force generator in comparison to similar sized pneumatic cylinders. For instance, force to size can be perhaps 20% of a pneumatic device. However, a linear motor's programmable speed, position and programmable force mode can result in a number of advantages when compared to some pneumatic devices. Such as advantages can include: a) very repeatable operation, in the order of 1 msec or less because of an ability to quickly find a work surface and then “softland” on it; and b) longer cycle life than many pneumatic cylinders. Cycle life can normally be expected to exceed pneumatic cylinders by a factor of 10× or more. In addition, because of the soft contact on a surface, noise can be reduced.

A method and device capable of performing “softlands” is described, for example, in SMAC's U.S. Pat. No. 5,952,589 entitled “Soft Landing Method For Probe Assembly,” the entirety of which is incorporated by reference herein.

### SUMMARY OF THE INVENTION

Some embodiments of the present invention can address the above and other needs by providing new methods and systems that can combine some or all of the benefits of pneumatic and linear electric devices described above. Since such devices can have some or all of these benefits, a combination of a pneumatic and linear electric device, in certain applications, can be very useful. In one embodiment, a device can combine the beneficial compact force capability of pneumatic cylinders with the programmable control features of linear servo motors, which can result in highly repeatable, high-force linear actuator systems. These systems can last a long time, can have “soft lands” and can also work relatively quietly.

In accordance with some embodiments, a linear actuator system can be used to move a probe along a substantially linear path. The linear actuator system can have a housing with a magnet mounted in the housing for creating a magnetic field. An electric coil piston can be slidably mounted in the housing. The coil piston can have a coil for carrying a current and can be disposed for translational movement within the magnetic field in response to current flow through the coil. The probe can be attached to the coil for translational movement with the coil. In addition, a pneumatic cylinder can be connected to the coil piston configured to apply a force to the coil piston in response to an activation of the pneumatic cylinder. The pneumatic cylinder can have a shaft connected to both the coil piston and a wall that defines separate a first and second interior chambers in the pneumatic cylinder. A first air pressure valve can be in communication with the first interior chamber and a second air pressure valve can be in communication with the second interior chamber. Each of the first and second air pressure valves can be configured to permit air to flow in and out of the respective first and second air chambers.

Furthermore, a sensor can be positioned in the housing. The sensor can be configured to generate signals indicating the position of the coil piston in the housing. A voltage source can also be operatively connected to the coil to supply a current through the coil and a pump can be operatively connected to the pneumatic cylinder to apply an air pressure to the pneumatic cylinder.

In addition, a computer can be operatively connected to the sensor, the voltage source and the pump. The computer can be configured to receive the signals generated by the sensor and control the voltage source and the pump in accordance with computer-readable instructions stored in the computer.

In accordance with some embodiments, a method is provided for moving a probe along a substantially linear path into contact with a work surface. The method can include applying a first activating force on the probe in a direction substantially aligned with the path to move the probe into a predetermined distance from the work surface. The first activating force can be supplied by an electric linear motor assembly operatively connected to the probe. In addition, the method can include applying a second activating force on the probe in a direction substantially aligned with the path to apply a predetermined force on the work surface. The second activating force can be applied by a pneumatic linear cylinder operatively connected to the probe. The first activating force can perform by applying a current through a coil piston by activating a voltage source to supply a current to the coil piston. The second activating force can be applied by supplying an air pressure to a first chamber of the pneumatic linear cylinder by activating a pump to apply air pressure to the first chamber or by switching a valve to apply air pressure to the first chamber.

### BRIEF DESCRIPTION OF THE DRAWINGS

For a better understanding of the aforementioned embodiments of the invention as well as additional embodiments thereof, reference should be made to the Detailed Description of the Embodiments below, in conjunction with the following drawings in which like reference numerals refer to corresponding parts throughout the figures.

FIG. 1 illustrates a cross-sectional view of a combination electric and pneumatic linear actuator device, in accordance with various embodiments of the invention.

FIG. 2 illustrates a block diagram of a combination electric and pneumatic linear actuator device connected to a computer, voltage source and pump, in accordance with some embodiments.

FIG. 3 illustrates a front perspective view of a combination electric and pneumatic linear actuator, in accordance with various embodiments of the invention.

FIG. 4 illustrates a rear perspective view of a combination electric and pneumatic linear actuator, in accordance with various embodiments of the invention.

FIG. 5 is a flow chart illustrating an exemplary process for operating a combination electric and pneumatic linear actuator device in accordance with some embodiments.

### DETAILED DESCRIPTION

In the following description of embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the present invention.

The figures provided are merely representational and may not be drawn to scale. Certain proportions thereof may be exaggerated, while others may be minimized. The figures are intended to illustrate various embodiments of the invention that can be understood and appropriately carried out by those of ordinary skill in the art. Commonly designated elements among the various figures refer to common or equivalent elements in the depicted embodiments. The figures are not intended to be exhaustive or to limit the invention to the precise form disclosed. It should be understood that the invention can be practiced with modification and alteration, and that the invention be limited only by the claims and the equivalents thereof.

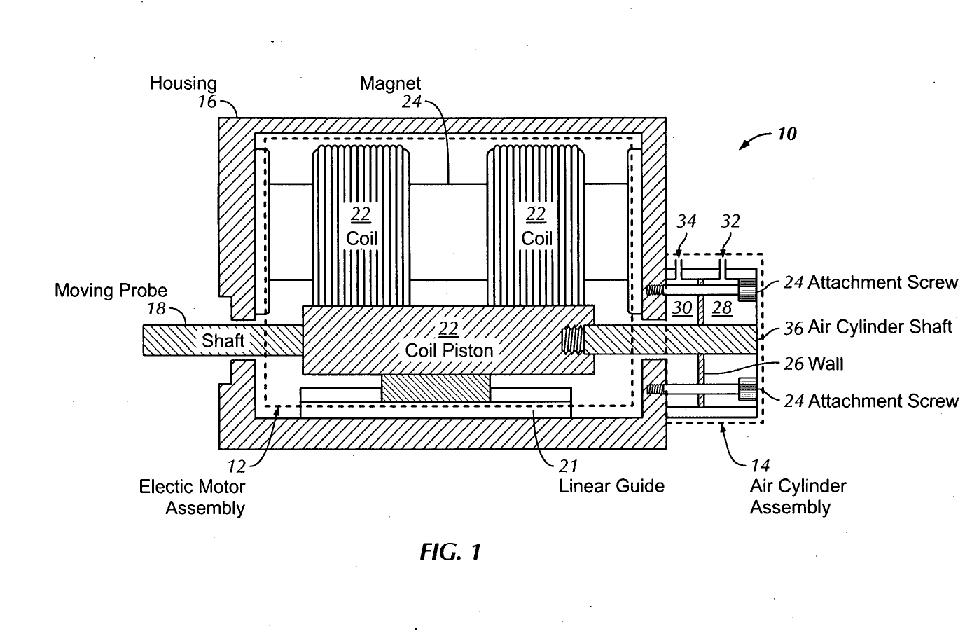

FIG. 1 is a cross sectional view of an exemplary device 10 for performing the methods of embodiments of the present invention. In general, the device 10 can include a linear motor assembly (generally indicated as reference numeral 12) attached to an air cylinder assembly (generally indicated as reference numeral 14). The linear motor assembly 12 can be of the type similarly used in SMAC's LA90 series or MLA55 series actuators, or described in the above-referenced U.S. Pat. No. 5,952,589 entitled “Soft Landing Method For Probe Assembly,” the entirety of which is incorporated by reference again herein. The air cylinder assembly 14 can be similar to SMC CQ2 air cylinder, for example, manufactured by SMC Corp. of America.

Further to FIG. 1, the device 10 can include a main housing 16 having a probe 18 partially extending out of an opening of the housing 16. The probe 18 can be attached to a coil piston 20 that can be slidably mounted on a linear guide 21 inside first housing 12. The coil piston 20 can include coils 22 partially surrounding a magnet 24. The magnet 24 can be attached at both ends to the housing 16. This arrangement can allow the coil piston 20 to slidingly move within the housing 16. Moreover, windings of coils 22 can be orientated in such way (e.g., substantially perpendicular to the flux field generated by the magnet) so that application of an electrical current to the coils 22 can generate a force on the coil piston 20. This force can cause the coil piston 12 to move within the housing 16, which can cause probe shaft 18 to make contact with a working surface or object or retract from a working surface or object, for example.

FIG. 1 illustrates the air cylinder assembly 14 mounted to the main housing 16 via attachment screws 24. However, in accordance with some embodiments, the air cylinder assembly 14 can be integral with the linear motor assembly 12 can be incorporated within a single housing. The air cylinder assembly 14 can have a chamber wall 26 extending through an interior of the air cylinder assembly 14, thereby dividing the cylinder assembly into two chambers: a first chamber 28 and a second chamber 30. A first air pressure valve 32 can extend into the first chamber 28 and a second air pressure valve 34 can extend into second chamber 30. Each of the first and second air pressure valves 32 and 34 can be used to inject air into or expel air out of the respective chambers 28 and 30. The air cylinder assembly 14 can also include shaft 36 attached to the wall 26 in such a way that movement of the wall 26 can cause corresponding movement of the shaft 36. As illustrated in FIG. 1, the shaft 36 can extend through an opening of the main housing 16 be connected to an end of the piston 20. The shaft 36 can be connected to the piston 12 through any suitable coupling mechanism. In some embodiments, the shaft 16 can be threadably engaged with the piston 12.

In operation, air can be injected into or taken out of the first chamber 28 via the first valve 32. Injecting air into the first chamber 28 can increase the pressure in the first chamber 28, causing the first chamber 28 to expand. Expansion of the first chamber 28 can cause and the second chamber 30 to contract. Air in the second chamber 30 can be expelled out of the second valve 34 as the second chamber 30 contracts. In contrast, reducing the pressure in the first chamber 28 (e.g., by taking air out of the first chamber 28 or injecting air into the second chamber 30) can cause the first chamber 28 to contract and the second chamber 30 to expand. As can be appreciated, expansion and contraction of the first and second chambers 28 and 30 can cause the wall 26 to move forward and backwards, respectively. Because the shaft 36 is connected to the wall 26, movement of the wall 26 can cause the shaft 16 to move and, by extension, the probe 18. Thus, air cylinder assembly 14 can move the probe 18 by changing the air pressure in the chambers 28 and 30.

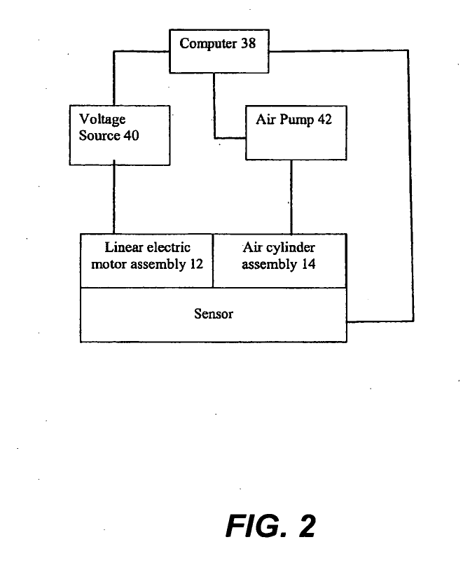

FIG. 2 is a block diagram of device 10 connected to a computer controller 38, a voltage source, and a pump 42. FIG. 2 also illustrates that a sensor 44 is incorporated into the device 10. In general, the computer 38 can control the movement of the probe 18 by controlling the voltage applied to the device 10 via the voltage source 40 and the air pressure applied to the device 10 via the pump 42. The computer 38 can also obtain information relating to the position of the probe 18 via sensor 44. In accordance with some embodiments, control over the movement of coil piston 20 and pneumatic air cylinder shaft 36, and thus control over the probe 18, can be achieved by monitoring the position of coil piston 20 relative to the housing 16. This can be done using the sensor 44. The sensor 44 can be a model SRL 4 encoder manufactured by Dynamics Research Corporation, which can be fixedly attached to the housing 16. Use of such a sensor (e.g., encoder) is described in more detail in U.S. Pat. No. 5,446,323 entitled “Actuator with Translational and Rotational Control,” the entirety of which is incorporated by reference herein.

A computer 38 can be control functionality described herein. One such example computing system is shown in FIG. 2. Various embodiments are described in terms of this example computer 38. After reading this description, it will become apparent to a person skilled in the relevant art how to implement the invention using other computer systems or architectures.

Referring now to FIG. 2, computer 38 may represent, for example, desktop, laptop and notebook computers; hand held computing devices (PDA's, cell phones, palmtops, etc.); mainframes, supercomputers, or servers; or any other type of special or general purpose computing devices as may be desirable or appropriate for a given application or environment. Computer 38 can include one or more processors, and each processor can be implemented using a general or special purpose processing engine such as, for example, a microprocessor, controller or other control logic.

Computer 38 can also include a main memory, preferably random access memory (RAM) or other dynamic memory, for storing information and instructions to be executed by processor. The main memory also may be used for storing temporary variables or other intermediate information during execution of instructions to be executed by processor. Computer 38 can likewise include a read only memory (“ROM”) or other static storage device coupled to bus for storing static information and instructions for processor.

The computer 38 can also include an information storage mechanism, which can include, for example, a media drive and a removable storage interface. The media drive can include a drive or other mechanism to support fixed or removable storage media. For example, a hard disk drive a floppy disk drive, a magnetic tape drive, an optical disk drive, a CD or DVD drive (R or RW), or other removable or fixed media drive. Storage media can include, for example, a hard disk, a floppy disk, magnetic tape, optical disk, a CD or DVD, or other fixed or removable medium that is read by and written to by media drive. As these examples illustrate, the storage media can include a computer usable storage medium having stored therein particular computer software or data.

In this document, the terms “computer program medium”, “computer-readable media” and “computer usable medium” are used to generally refer to media such as, for example, memory, storage device, a hard disk installed in hard disk drive, and signals on channel. These and other various forms of computer usable media may be involved in carrying one or more sequences of one or more instructions to processor for execution. Such instructions, generally referred to as “computer program code” (which may be grouped in the form of computer programs or other groupings), when executed, enable the computer 38 to perform features or functions of the present invention as discussed herein.

In an embodiment where the elements are implemented using software, the software may be stored in a computer program medium and loaded into computer 38 using a removable storage drive, a hard drive or communications interface. The control logic (in this example, software instructions or computer program code), when executed by the processor, can causes the processor to perform the functions of the invention as described herein.

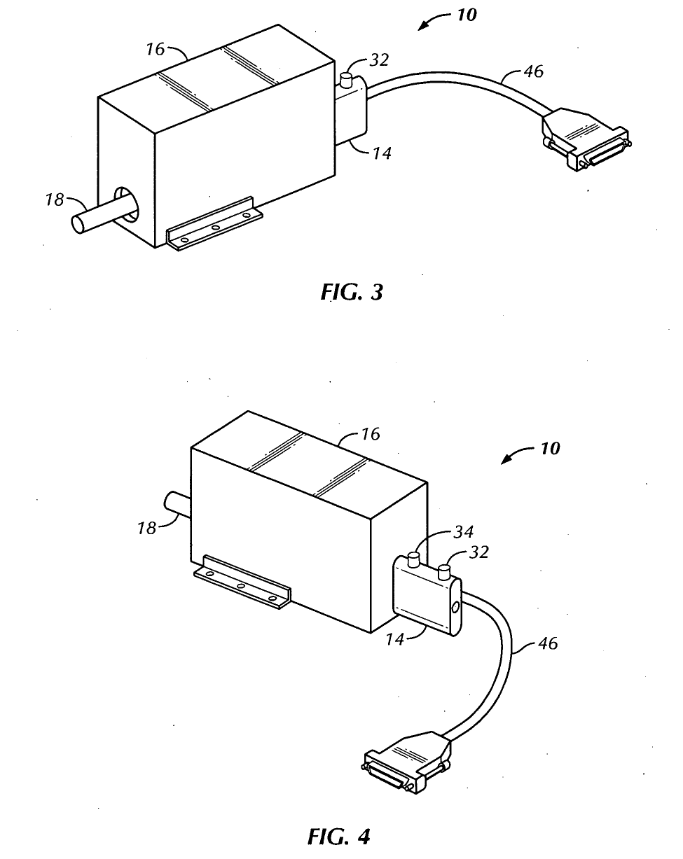

FIGS. 3 and 4 illustrate perspective views of the device 10, in accordance with some embodiments of the invention. As shown in FIGS. 1 and 3, the air cylinder assembly 14 may be attached to the rear of the housing 16. A cable 46 can be used to connect device 10 with computer 38 and voltage source 40, for example.

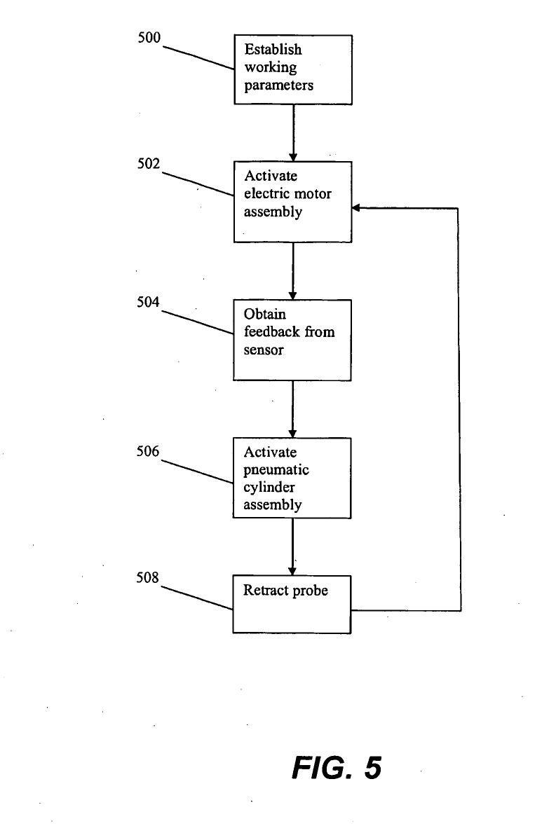

An exemplary operation of the device 10 is described with reference to the flowchart shown in FIG. 5.

In step 500, device 10 can be calibrated and instructions can be programmed into computer 38 for controlling device 10. Calibration can include identifying the position of the probe 18 relative to readings supplied by the sensor 44. The instructions programmed into the computer 38 can include the amount of force that is to be applied by the linear motor assembly and the air cylinder assembly and duration of time for application of such force, for example. Of course other instructions relating to operation of the device can be programmed into computer 38 as well.

In step 502, computer 44 can control voltage source 40 to apply a desired voltage to the linear motor assembly 12. This can cause the linear motor assembly 12 to cause the probe 18 to move a predetermined distance along a substantially linear path. For example, the probe 18 can extend to a work surface and “softland” on the work surface, thereby establishing a work point. At this time, the pneumatic cylinder shaft 16 need not have any air pressure being applied to it and, hence, no force need be applied by it on the device 10 during a softland process.

The sensor 44 can supply feedback to the computer 38 indicating that the probe 18 has moved the predetermined distance (e.g., to a work surface) in step 504. Once reached, computer 38 can activate pump 42 to apply air pressure the first chamber 28 in step 506. Alternatively, a pneumatic valve connected to the air cylinder assembly 14 can be switched to apply air pressure to the first chamber 28. As air is injected into the first chamber 28, the air pressure can cause a chamber wall 26 to move forward. The chamber wall 26 moving forward can push the air cylinder shaft 36 forward and, hence, cause the piston 20 and probe 18 to move forward. Thus cam applying a predetermined force on a worksurface, for example.

After a desired probe movement is achieved, pump 42 can be turned off or a pneumatic valve can switched; whereby the pressure is reduced in the first chamber 28 and the linear motor 12 can returns to its retracted position in step 508.

The process can then return to step 502 and repeat steps 502 through 508.

In some embodiments, device 10 can repeatably land on a work surface in approximately a millisecond variation or less. A relatively high force can be applied by the air cylinder and transferred to the work surface by the linear motor piston/shaft. In addition, a fast return motion can be achieved. There can also be less or even no shock to the air cylinder, which means that the air cylinder's life can approach that of the linear motor. Furthermore, device 10 can prevent or reduce slamming of the air cylinder piston into an end stop, which can result in reduced noised caused by operation of device 10.

Because of the electric linear motor force programmability, the device's 10 application of force can be ramped up at the start if needed. The linear motor's built in position sensor 44 can also verify that probe 18 movement meets dimensional requirements and that there is substantially no variation after the large pneumatic force is stopped.

In an alternative embodiment, it is possible to use a solenoid instead of an air cylinder in applications where the force required is relatively small.

As used herein, the term “air” is defined in its broadest sense of its dictionary meaning, and can include pressurized gas. Furthermore, in some embodiments, the device can use liquids to perform the desired functions.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

What is claimed is:

1. A linear actuator system, comprising:
a housing;
a magnet mounted in the housing creating a magnetic field;
an electric coil piston slidably mounted on said housing, the coil piston having a coil for carrying a current, the coil being disposed for translational movement within the magnetic field in response to current flow through the coil;
a probe attached to the coil for translational movement with the coil;
a pneumatic cylinder connected to the piston configured to apply a force to the piston in response to an activation of the pneumatic cylinder.

2. The linear actuator system of claim 1, wherein the pneumatic cylinder comprises a shaft attached to a wall, wherein the wall separates a first and second interior chamber.

3. The linear actuator system of claim 2, further comprising a first air pressure valve in communication with the first interior chamber and a second air pressure valve in communication with the second interior chamber, the first and second air pressure valves configured to permit air to flow in and out of the respective first and second air chambers.

4. The linear actuator system of claim 1, wherein the coil piston is attached to a linear guide rail.

5. The linear actuator system of claim 1, further comprising:
a sensor positioned in the housing configured to generate signals indicating the position of the coil piston in the housing;
a voltage source operatively connected to the coil configured to supply a current through the coil;
a pump operatively connected to the pneumatic cylinder configured to apply an air pressure to the pneumatic cylinder.

6. The linear actuator system of claim 1, further comprising a computer operatively connected to the sensor, the voltage source and the pump, wherein the computer is configured to receive the signals generated by the sensor and control the voltage source and the pump in accordance with computer-readable instructions stored in the computer.

7. A method for moving a probe along a substantially linear path into contact with a work surface, comprising;
applying a first activating force on the probe in a direction substantially aligned with the path to move the probe into a predetermined distance from the work surface, the first activating force being supplied by an electric linear motor assembly operatively connected to the probe;
applying a second activating force on the probe in a direction substantially aligned with the path to apply a predetermined force on the work surface, the second activating force being applied by a pneumatic linear cylinder operatively connected to the probe.

8. The method of claim 7, wherein applying the first activating force further comprises applying a current through a coil piston.

9. The method of claim 8, further comprising activating a voltage source to supply a current to the coil piston.

10. The method of claim 7, wherein applying the second activating force further comprises applying air pressure to a first chamber of the pneumatic linear cylinder, which causes a shaft operatively connected to the probe to apply a force to the probe.

11. The method of claim 10, further comprising activating a pump to apply air pressure to the first chamber.

12. The method of claim 10, further comprising switching a valve to apply air pressure to the first chamber.

13. A linear actuator system, comprising:
a linear actuator having a probe configured to reciprocate along a substantially linear path in response to forces applied by an electric linear motor assembly and a pneumatic air cylinder assembly;
a sensor configured to generate signals indicating a position of the probe along the substantially linear path;
a computer operatively connected to the sensor, the electric linear motor assembly and the pneumatic air cylinder; and
a computer-readable medium, wherein the computer-readable medium is stored in memory of the computer and configured to be executed by the one or more processors of the computer, the computer-readable medium including:
instructions for calibrating the linear actuator assembly;
instructions for determining the position of the probe along the substantially linear path;
instructions for activating the electric motor assembly to cause the electric motor assembly to apply a predetermined force to the probe; and
instructions for activating the pneumatic air cylinder assembly to cause the pneumatic air cylinder assembly to apply a predetermined force to the probe.

14. A linear actuator system, comprising:
a probe configured to slide along a substantially linear path;
a electric means coupled to the probe for applying a first force to the probe in response to a current being applied to the electric means; and
a pneumatic means coupled to the probe for applying a second force in response to an air pressure being applied to the pneumatic means.

15. The linear actuator system of claim 14, further comprising a computer means for controlling the current being applied to the electric means and the air pressure being applied to the pneumatic means.
